(19) United States
(12) Patent Application Publication
(10) Pub. No.: US 2004/0023117 A1
(43) Pub. Date: Feb. 5, 2004

(54) Nonaqueous electrolyte battery

(76) Inventors: Naoki Imachi, Kobe-city (JP); Seiji Yoshimura, Kobe-city (JP); Shin Fujitani, Kobe-city (JP)

Correspondence Address: KUBOVCIK & KUBOVCIK, SUITE 710, 900 17TH STREET NW, WASHINGTON, DC, 20006

(21) Appl. No.: 10/627,677

(22) Filed: Jul. 28, 2003

(30) Foreign Application Priority Data
Jul. 31, 2002 (JP) 2002-223010

(51) Int. Cl. H01M 4/58; H01M 4/50; H01M 4/66; H01M 4/48

(52) U.S. Cl. 429/231.95; 429/245; 429/231.8; 429/231.1; 429/231.5; 429/231.3; 429/224

(57) ABSTRACT

A nonaqueous electrolyte battery includes a positive electrode containing a positive electrode active material which is capable of occluding and releasing lithium, a negative electrode containing a main active material which is capable of occluding and releasing lithium, and a current collector of copper, wherein the negative electrode contains a subsidiary active material which supplies lithium from the negative electrode to the positive electrode at an overdischarge condition. This arrangement makes it possible to prevent deterioration of battery characteristics caused by overdischarge without using an external device such as a protective element or protective circuit.

### FIELD OF THE INVENTION

The present invention relates to a nonaqueous electrolyte battery. Specifically, the present invention relates to a lithium secondary battery which is capable of preventing deterioration of battery characteristics without an external control device such as a protective element or a protective circuit.

### BACKGROUND OF THE INVENTION

A lithium secondary battery uses highly efficient and highly reliable materials to obtain stability and reliability. A protective element such as a positive temperature coefficient element (PTC) or a protective circuit such as a protective circuit board (PCB) is used with such batteries to increase the reliability of battery packs. However, such devices are expensive and reduce volume energy density. Therefore, battery materials and structures have recently been improved for the purpose of eliminating such devices.

As means to prevent overcharging, use of a positive electrode material having high thermostability such as lithium manganate and improvement of electrolytes have significantly increased reliability.

However, there is a problem caused by overdischarge during long term storage. Self-discharge occurs because an organic solvent is used as the electrolyte and metal oxide is used as a positive electrode active material and copper of a current collector of a negative electrode is dissolved when battery voltage decreases to close to 0 V.

As a step to prevent overdischarge, it has been attempted to precisely control battery voltage by using a secondary device such as a protective element or a protective circuit. However, it is necessary to improve materials or design to eliminate such devices.

It is desirable to change the design of nonaqueous electrolyte batteries so that a lower limit of cut off voltage is controlled by the positive electrode potential and dissolution of copper is prevented instead of the negative electrode potential which is currently used to control discharge. If usual materials are used after such design change is made, there are problems that lithium from the positive electrode is deposited on the negative electrode during the initial charge and overcharge characteristics are significantly deteriorated.

It is effective to use a positive electrode material having very poor load characteristics as a modified material to minimize such problems. However, if such modified material is used for the positive electrode, charge discharge characteristics of the battery are also deteriorated. It is thus difficult to solve the problems which are caused by overdischarge without affecting total battery characteristics.

### OBJECT OF THE INVENTION

An object of the present invention is to provide a nonaqueous electrolyte battery which is capable of preventing deterioration of battery characteristics caused by overdischarge without using an external device such as a protective element or a protective circuit.

### SUMMARY OF THE INVENTION

A nonaqueous electrolyte battery according to the present invention includes a positive electrode containing a positive electrode active material which is capable of occluding and releasing lithium, a negative electrode containing a main active material which is capable of occluding and releasing lithium, and a current collector of copper, wherein the negative electrode contains a subsidiary active material which supplies lithium from the negative electrode to the positive electrode at an overdischarge condition. This makes it possible to reduce a potential of the positive electrode by saturating lithium occluding at the positive electrode and to terminate discharge before a potential of the negative electrode reaches a potential at which copper is dissolved.

### BRIEF DESCRIPTION OF THE DRAWINGS

FIG. 1 is a graph showing overdischarge characteristics of the battery in the Example.

FIG. 2 is a graph showing overdischarge characteristics of the battery in the Comparative Example.

FIG. 3 is a graph showing voltage changes of positive electrode materials at the final stage of discharge.

### DETAILED EXPLANATION OF THE INVENTION

When lithium cobalt oxide or lithium manganate is used as a positive electrode active material, and a carbon material is used as a negative electrode active material, charge and discharge is normally performed in a range of 4.2˜2.75 V. Therefore, in the present invention, a subsidiary active material for the negative electrode is used which can provide lithium from the negative electrode to the positive electrode in a range of overdischarge of 2.75 V or less.

In the present invention, the battery is designed so that the positive electrode potential controls battery voltage in a range of overdischarge, and discharge is terminated by reduction of the positive electrode potential. Therefore, as the subsidiary active material, a material is used which can occlude and release lithium at a lower potential than the potential at which copper is dissolved.

When the negative electrode active material is a carbon material, the material used as the subsidiary active material is one which occludes and releases lithium at a higher potential than the potential at which the carbon material occludes and releases lithium, and at a lower potential than that at which copper is dissolved. A material which can occlude and release lithium at a potential of lower than 3.0 V is used as the subsidiary active material because the potential at which copper is dissolved is not less than 3.0 V, when the potential is measured using lithium as a counter electrode (i.e., a potential using lithium as a standard). As the subsidiary active material, lithium titanate can be exemplified. As the lithium titanate, Li₂TiO₃, Li₄Ti₅O₁₂, Li₄Ti₁₁O₂₀ and Li₂Ti₃O₇ can be mentioned.

If the subsidiary active material occludes lithium during the first charge cycle, it is preferable to provide the negative electrode with an amount of lithium that can be occluded by the subsidiary active material. The negative electrode can be provided with lithium, for example, by adhering lithium metal to the negative electrode. Lithium metal adhered to the negative electrode is believed to occlude electrochemically in a main active material such as carbon.

In the present invention, the subsidiary active material does not participate in the regular charge/discharge reaction. Thus, it is possible to prevent deterioration of battery characteristics caused by overdischarge while maintaining regular battery performance.

A secondary battery for lithium including lithium cobalt oxide as a positive electrode active material and graphite as a negative electrode active material generally charges and discharges in a range of 4.2˜2.75 V. Lithium cobalt oxide has a capacity of about 160 mAh/g, and an initial charge/discharge efficiency of about 95˜98%. Graphite has a capacity of about 350˜380 mAh/g, and an initial charge/discharge efficiency of about 90˜94%. The possible amount of lithium to be transferred between the positive and negative electrodes is basically determined by the amount of the positive electrode active material and the initial charge/discharge efficiency of the negative electrode.

Due to the fact that deposition of lithium on a surface of the electrodes during charge and discharge causes decomposition of an electrolyte and deterioration of reliability, a battery is designed so as not to deposit lithium in a regular voltage range of 4.2˜2.75 V. That is, an amount of lithium that the negative electrode can occlude during the initial charge (initial negative electrode charge capacity) is designed to be greater than the amount of lithium that the positive electrode can release (initial positive electrode charge capacity).

In the present invention, it is preferable that a ratio of initial negative electrode charge capacity to initial positive electrode charge capacity is in a range of 1.0 to 1.2. If the positive electrode charge capacity is too great, lithium metal will deposit on the negative electrode and reliability will be deteriorated. If the negative electrode charge capacity is too great, negative electrode capacity is consumed at the negative electrode during the initial charge/discharge and may reduce energy density.

In the present invention, the subsidiary active material is used in an amount sufficient to cause saturation of lithium occluding at the positive electrode before the negative electrode potential reaches the potential at which copper is dissolved. The amount in terms of charge capacity can be calculated the following expression.

(Initial positive electrode charge capacity×initial positive electrode charge/discharge efficiency/100)−{initial positive electrode charge capacity−initial negative electrode charge capacity×(100−initial negative electrode charge/discharge efficiency)/100}. As explained below, an amount of lithium capable of transferring between the positive and negative electrodes is subtracted from an effective positive electrode capacity in the above expression.

Initial positive electrode charge capacity×initial positive electrode charge/discharge efficiency/100=effective positive electrode capacity

Initial positive electrode charge capacity−initial negative electrode charge capacity×(100−initial negative electrode charge/discharge efficiency/100)=amount of lithium capable of transferring between the positive and negative electrodes.

Therefore, if the subsidiary active material is added in an amount in terms of charge capacity at least equivalent to the difference in capacity obtained according to the above expression, it is possible that lithium is supplied from the negative electrode to the positive electrode to saturate the lithium occluding in the positive electrode.

When lithium titanate is used as the subsidiary active material, the diameter of particles of the lithium titanate is preferably not greater than 5 μm. The reason for this limitation is that the particles of lithium titanate are hard and when they are mixed with an active material such as carbon material to be coated onto the negative electrode current collector and rolled under pressure, a current collector of a copper foil is easily physically damaged. If surfaces of the electrode are not even, the charge/discharge reaction does not progress smoothly and poor quality results when the electrode is spirally rolled. If lithium titanate having a greater particle size is used, dispersibility in a negative electrode slurry is reduced. Therefore, a smaller lithium titanate particle diameter is better.

To minimize damage to copper foil during pressure rolling, the diameter of particles of lithium titanate is preferably not greater than 5 μm and, more preferably, not greater than 1 μm. To obtain reasonable slurry dispersibility, the diameter of particles of lithium titanate is preferably not greater than 5 μm and, more preferably, not greater than 3 μm.

There is no limitation with respect to the negative electrode main active material to be used in the present invention if it is an active material capable of occluding lithium at a lower potential than the negative electrode subsidiary active material. A carbon material is preferably used. As the carbon material, natural graphite, artificial graphite, hard (graphitized) carbon, a sintered organic compound such as phenol resin, coke, and the like, can be exemplified. These materials can be used alone or in combinations thereof. A material capable of occluding and releasing lithium ion, for example, tin oxide, lithium metal, silicon, and the like, can be mixed with the negative electrode main active material.

The current collector of the present invention includes copper. The current collector can be a copper foil, or a copper alloy foil. It is possible to use a copper foil coated with a metal layer, or a metal foil coated with copper.

There is no limitation with respect to the positive electrode active material to be used in the present invention if it is an active material capable of occluding and releasing lithium. The active material is one having a discharge capacity of not greater than 5 mAh/g at a potential in the range of 3.7˜3.1 V, measured using lithium as a counter electrode. That is, at the end of discharge at 3.7˜3.1 V, a material which dramatically decreases voltage is preferably used. The reason for this is that in the present invention, battery voltage is controlled by the positive electrode potential when the battery is overdischarged and discharge is terminated by dramatically decreasing the positive electrode potential before a negative electrode potential reaches a potential at which copper is dissolved.

As the positive electrode active material in the present invention, lithium cobalt oxide or lithium manganate is preferably used. As the positive electrode active material, a material having a greater initial charge/discharge efficiency than that of the negative electrode active material is preferably used.

In such combination of the positive electrode active material and the negative electrode active material, the negative electrode subsidiary active material is used to make it possible for voltage to be controlled the positive electrode potential during overdischarge and to stop discharge.

There is no limitation with respect to the nonaqueous electrolyte to be used in the present invention and an electrolyte generally used for a nonaqueous electrolyte battery can be used. As a solute, a lithium salt is used. LiClO₄, LiBF₄, LiN(SO₂CF₃)₂, LiN(SO₂C₂F₅)₂, LiPF₆₋ₓ(CₙF₂ₙ₊₁)ₓ (wherein 1≦×≦6, n=1 or 2), and the like can be exemplified and can be used alone or in combinations thereof. There is no limitation with respect to the concentration of the solute but it is preferably 0.2˜1.5 mol per 1 l of the electrolyte.

As a solvent for the nonaqueous electrolyte, cyclic carbonates, for example, ethylene carbonate, propylene carbonate, butylene carbonate, and the like; chain carbonates, for example, dimethyl carbonate, ethylmethyl carbonate, diethyl carbonate, methylethyl carbonate, ethylpropyl carbonate, methylisopropyl carbonate, and the like; chain esters, for example, methyl acetate, ethyl acetate, propyl acetate, methyl propionate, ethyl propionate, and the like; cyclic carboxylates, for example, γ-butyrolactone, and the like; ethers, for example, tetrahydrofuran, 2-methyl tetrahydrofuran, 1,4-dioxane, 1,2-dimethoxyethane, 1,2-diethoxyethane, and the like; nitriles, for example, acetonitrile, and the like; amides, for example, dimethylformamide, and the like, can be used alone or in combinations thereof. When a mixed solvent is used, it is preferable to use a mixture of a cyclic carbonate and a chain carbonate. As a cyclic carbonate, ethylene carbonate is preferable and as a chain carbonate, diethyl carbonate is preferable.

The nonaqueous electrolyte battery of the present invention can be a polymer battery using a gel electrolyte. As a polymer material, polyether solid polymer, polycarbonate solid polymer, polyacrylonitrile solid polymer, copolymers thereof and crosslinked polymers can be illustrated. A solid electrolyte prepared from a mixture of the polymer material, lithium salt and electrolyte can be used.

Generally, it is likely that copper dissolves from a current collector when discharge is performed at a low rate. That is, when discharge is performed at a low rate, a condition without lithium in the negative electrode is created to increase the negative electrode potential and to reach a potential at which copper is dissolved. If the battery is discharged at a high rate like an IC, load characteristics of the positive and negative electrode active materials are strongly affected and lithium tends to remain in the negative electrode and it is unlikely to cause a problem such as the dissolution of copper.

### DESCRIPTION OF PREFERRED EMBODIMENT

Embodiments of the present invention are explained in detail below. It is of course understood that the present invention is not limited to these embodiments and can be modified within the spirit and scope of the appended claims.

### EXAMPLES

[Preparation of Positive Electrode]

Lithium cobalt oxide as a positive electrode active material and graphite as a carbon conductive agent were mixed at a ratio by mass of 92:5 to prepare a positive electrode mixture powder. 200 g of the positive electrode active material mixture powder was applied to a mechanofusion apparatus (Hosokawa Micron Co. Model No. AF-15F), and the apparatus was operated at 1,500 rpm for ten minutes to mix the powder. Then the positive electrode mixture powder was mixed with polyvinylidene fluoride (PVDF) as a fluorine resin binder in N-methylpyrrolidone in a ratio by mass of 97:3 to make a slurry. Then the slurry was coated on both sides of an aluminum foil (having a thickness of 15 μm) and dried, and was pressure rolled to prepare a positive electrode. The amount of the positive electrode mixture coating was 5.19 g.

[Preparation of Negative Electrode]

Graphite was used as a negative electrode main active material, and lithium titanate (Li₄Ti₅O₁₂) having a mean particle diameter (D₅₀) of 3 μm was used as a negative electrode subsidiary active material. About 2.60 g of the graphite, 0.246 g of the lithium titanate and styrene-butadiene rubber (SBR) as a binder were mixed to form a mixture. The graphite and SBR were used in a ratio by mass of 98:2. The mixture was coated on both sides of a copper foil (having a thickness of 12 μm) and dried, and was pressure rolled to prepare a negative electrode. 9.6 mg of lithium metal foil was adhered on parts of the copper foil where the negative electrode active material and the negative electrode subsidiary active material were not coated.

[Assembly of Battery]

After leads were mounted on the positive and negative electrodes as terminals, a separator made of polyethylene was inserted between the positive and negative electrodes and the resultant laminate was spirally rolled and placed in a battery can made of aluminum. An electrolyte was poured into the can and the can was sealed to prepare a battery. As the electrolyte, 1 mol/l LiPF₆ dissolved in a mixture of ethylene carbonate and diethyl carbonate in a ratio by volume of 3:7 was used. Then the battery was aged at 60° C. for 15 hours to occlude lithium from the lithium metal foil adhered on the negative electrode to graphite in the negative electrode.

[Design of Battery]

The following are designs of the battery relating to the positive and negative electrodes.

An initial charge/discharge efficiency of lithium cobalt oxide used as the positive electrode active material is 96%. An initial charge capacity is 165 mAh/g. 92 weight % of the positive electrode mixture is the active material.

An initial charge/discharge efficiency of graphite used as the negative electrode main active material is 93%. 98 weight % of the mixture of the negative electrode main active material and the binder is the negative electrode main active material.

The ratio of initial negative electrode charge capacity/positive electrode charge capacity was designed to be 1.15. Since an amount of the positive electrode coating was 5.19 g, the initial positive electrode charge capacity is calculated as shown below.

$$The initial positive electrode charge capacity = 165 mAh \text{/} g \times 5.19 g \times 0.92 = 788 mAh$$

An effective positive electrode capacity is 96% (initial charge/discharge efficiency) of this number, i.e., 756 mAh.

Since the total amount of the coated negative electrode main active material and binder was 2.65 g, the initial negative electrode charge capacity is calculated as shown below.

$$The initial negative electrode charge capacity = 380 mAh \text{/} g \times 2.65 g \times 0.98 = 987 mAh$$

The total amount of the coating of the negative electrode main active material and binder on the portion of the negative electrode facing the positive electrode is 2.44 g which is equivalent to 2.39 g of the main active material. Therefore, the initial charge capacity and effective capacity of the portion facing the positive electrode are calculated below.

$$I nitial negative electrode charge capacity ( of the portion of the negative electrode facing the positive electrode ) = 2.39 g \times 380 mAh \text{/} g = 908 mAh$$

$$Effective negative electrode charge capacity ( of the portion of facing to the positive electrode ) = 2.39 g \times 380 mAh \text{/} g \times 0.93 = 845 mAh$$

The ratio of the initial negative electrode charge capacity/initial positive electrode charge capacity of 1.15 as described above was obtained on the basis of the initial negative electrode charge capacity (of the portion of the negative electrode facing the positive electrode)/initial positive electrode charge capacity (=908 mAh/788 mAh).

An amount of lithium capable of being transferred between the positive and negative electrodes (an amount of transferrable Li) can be calculated from the initial positive electrode charge capacity and the initial negative electrode charge capacity as follows:

(Please note that the initial negative electrode charge capacity used for this calculation includes all of the active material rather than the portion facing the positive electrode. This is because consumption of lithium on the negative electrode is an electrochemical reaction of the negative electrode active material, i.e., it depends on the total amount of the active material.)

$$The amount of transferrable Li = 788 mAh - ( 987 mAh \times ( 100 - 93 ) / 100 ) = 788 mAh - 69 mAh = 719 mAh$$

From this result, it is noted that an amount of lithium that is transferred from the negative electrode to the positive electrode when the battery is throughly discharged is 719 mAh. An amount of lithium that the positive electrode can occlude is 756 mAh. Therefore, the amount of lithium that the positive electrode can occlude is 37 mAh more than the amount of lithium that is transferred from the negative electrode to the positive electrode. 37 mAh is an amount of lithium that the positive electrode can further occlude even after the battery is throughly discharged. In the present invention, this amount of lithium is supplied to saturate the positive electrode by the subsidiary active material at a condition of overdischarge.

In the Example, 0.246 g of lithium titanate was used. This is equivalent to 37 mAh, which is the amount of lithium that the positive electrode can further occlude, because the charge capacity of lithium titanate is 150 mAh/g. 9.6 mg of the lithium metal foil adhered to the negative electrode is also equivalent to 37 mAh because the charge capacity of lithium metal is 3861 mAh/g.

[Evaluation of Overdischarge Characteristics]

The battery was charged to 4.2 V at a constant current of 700 mA at 25° C., and charging was continued at a constant voltage of 4.2 V to a current of not greater than 35 mA. Then the battery was discharged to 2.7 V at a constant current of 5 mA, and continued to discharge to 0.0 V at a constant current of 1 mA.

FIG. 1 is a graph showing battery voltage, positive electrode potential and negative electrode potential in an area of overdischarge of not greater than 2.75 V. As shown in FIG. 1, there is a plateau portion in a discharge plot of lithium titanate at a battery voltage of about 2.4 V. At the plateau portion, the negative electrode potential is 1.5 V. At the plateau portion, lithium is supplied from the negative electrode to the positive electrode. When lithium occlusion in the positive electrode is saturated, positive electrode potential is decreased. Therefore, discharge of the battery is terminated before the negative electrode potential reaches 3.0 V, a potential at which copper is dissolved.

The above-described overdischarge characteristics were reversible when charge and discharge cycles were repeated. Dissolution of copper into the electrolyte was not detected by measurement by ICP (inductively coupled plasma emission spectroscopy) and EPMA (electron probe microchemical analysis).

### Comparative Example

[Preparation of Negative Electrode]

A negative electrode was prepared in the same manner as the above Example except that lithium titanate was not included in the mixture and lithium metal foil was not adhered onto the current collector.

[Assembly of Battery]

A battery was assembled in the same manner as the above Example except that the negative electrode prepared above was used.

[Evaluation of Overdischarge Characteristics]

The battery in the Comparative Example was evaluated.

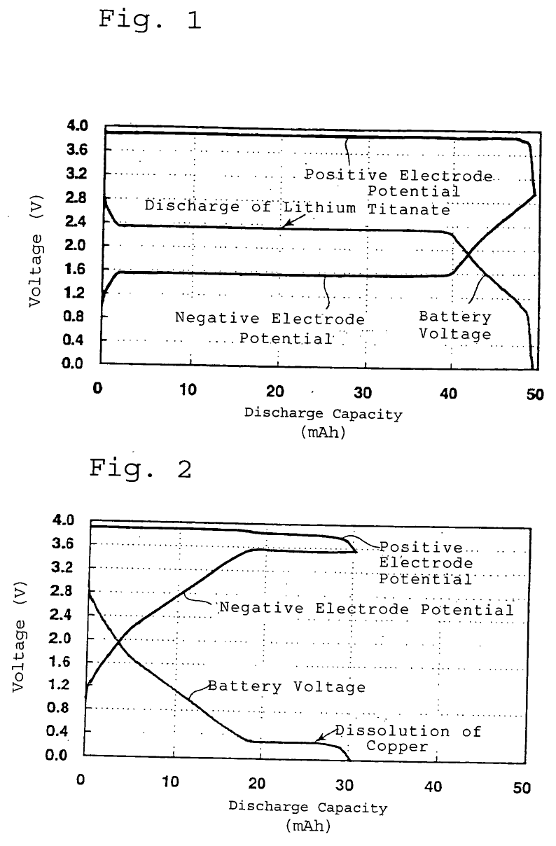

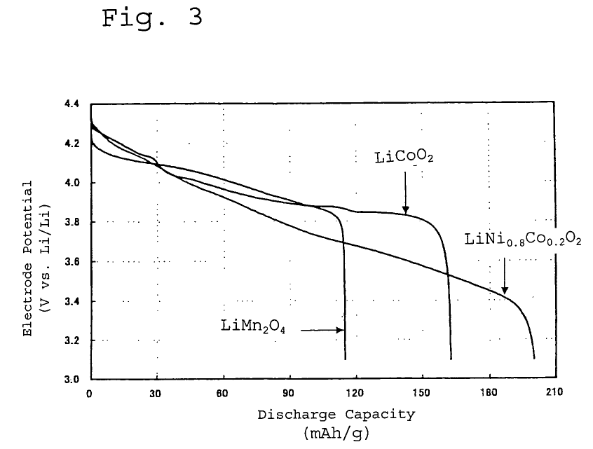

FIG. 2 is a graph showing evaluation results. As shown in FIG. 2, at a battery voltage of about 0.3 V, there was a plateau portion different from a regular charge and discharge reaction. Negative electrode potential increased to greater than 3.0 V corresponding to the plateau portion. As a result of measurements by ICP and EPMA, it was determined that copper was dissolved in the electrode. Therefore, it is understood that charge characteristics of the battery are seriously deteriorated by overdischarge and battery characteristics are deteriorated.

[Evaluation of Voltage Characteristics of Positive an Electrode Active Material at the Final Stage of Discharge]

FIG. 3 is a graph showing voltage changes of lithium cobalt oxide (LiCoO₂), lithium manganate (LiMn₂O₄) and lithium nickel cobalt oxide (LiNi_{0.8}Co_{0.2}O₂) at the final stage of discharge. These graphs were obtained by using three-electrode cells that were prepared using lithium cobalt oxide, lithium manganate and lithium nickel cobalt oxide as positive electrode active materials to prepare a positive electrode in the same manner as preparation of the positive electrode in the Example, and using lithium metal foil as a counter electrode and reference electrode. After the cells were charged at 0.25 mAhcm⁻²/4.3 V (an ending current of 0.5 mA), they were discharged to 3.10 V at a current of 0.25 mAhcm⁻² to determine the relationship between discharge capacity and electrode potential. The results are shown in FIG. 3.

As is clear from the results shown in FIG. 3, lithium cobalt oxide and lithium manganate have discharge curves in which discharge capacities in a range of 3.7˜3.1 V are not greater than 5 mAh/g. They are suitable as a positive electrode active material because their voltage drop at the final stage of discharge is drastic.

### ADVANTAGES OF THE INVENTION

The present invention makes it possible to prevent deterioration of battery characteristics caused by overdischarge without using an external device such as a protective element or protective circuit.

What is claimed is:

1. A nonaqueous electrolyte battery comprising a positive electrode containing a positive electrode active material that is capable of occluding and releasing lithium, a negative electrode containing a main active material that is capable of occluding and releasing lithium, and a current collector comprising copper,
wherein the negative electrode contains a subsidiary active material for supplying lithium from the negative electrode to the positive electrode at a condition of overdischarge, the subsidiary active material supplying lithium to the positive electrode to saturate lithium occluding at the positive electrode to reduce an electrical potential of the positive electrode and terminate discharge of the battery before an electrical potential of the negative electrode reaches the electrical potential at which copper is dissolved from the current collector.

2. The nonaqueous electrolyte battery according to claim 1, wherein the main active material of the negative electrode is carbon, and the subsidiary active material is an active material that occludes and releases lithium at an electrical potential that is a higher than an electrical potential at which the carbon occludes and releases lithium and is lower than an electrical potential at which copper is dissolved.

3. The nonaqueous electrolyte battery according to claim 1, wherein the subsidiary active material is lithium titanate.

4. The nonaqueous electrolyte battery according to claim 2, wherein the subsidiary active material is lithium titanate.

5. The nonaqueous electrolyte battery according to claim 3, wherein the lithium titanate is at least one titanate selected from the group consisting of Li₂TiO₃, Li₄Ti₅O₁₂, Li₄Ti₁₁O₂₀ and Li₂Ti₃O₇.

6. The nonaqueous electrolyte battery according to claim 4, wherein the lithium titanate is at least one titanate selected from the group consisting of Li₂TiO₃, Li₄Ti₅O₁₂, Li₄Ti₁₁O₂₀ and Li₂Ti₃O₇.

7. The nonaqueous electrolyte battery according to claim 3, wherein a particle diameter of the lithium titanate is not greater than 5 μm.

8. The nonaqueous electrolyte battery according to claim 4, wherein a particle diameter of the lithium titanate is not greater than 5 μm.

9. The nonaqueous electrolyte battery according to claim 5, wherein a particle diameter of the lithium titanate is not greater than 5 μm.

10. The nonaqueous electrolyte battery according to claim 6, wherein a particle diameter of the lithium titanate is not greater than 5 μm.

11. The nonaqueous electrolyte battery according to claim 1, wherein an amount of lithium which is able of being occluded at an initial charge is provided to the negative electrode in advance.

12. The nonaqueous electrolyte battery according to claim 11, wherein the lithium is provided to the negative electrode in advance by adhering lithium metal onto the negative elctrode.

13. The nonaqueous electrolyte battery according to claim 1, wherein a ratio of initial negative electrode charge capacity/positive electrode capacity is in a range of 1.0 and 1.2.

14. The nonaqueous electrolyte battery according to claim 1, wherein the subsidiary active material in terms of charge capacity, is contained in the negative electrode, in an amount determined from the following expression: (initial positive electrode charge capacity×initial positive electrode charge/discharge efficiency/100)−{initial positive electrode charge capacity−(initial negative electrode charge capacity×(100−initial negative electrode charge/discharge efficiency/100)}.

15. The nonaqueous electrolyte battery according to claim 1, wherein the positive electrode active material is an active material having a discharge capacity of not greater than 5 mAh/g at an electrical potential of 3.7˜3.1 V measured using lithium as a counter electrode.

16. The nonaqueous electrolyte battery according to claim 1, wherein the positive electrode active material is lithium cobalt oxide or lithium manganate.
